(19) United States
(12) Patent Application Publication
(10) Pub. No.: US 2014/0201542 A1
(43) Pub. Date: Jul. 17, 2014

(54) ADAPTIVE PERFORMANCE OPTIMIZATION OF SYSTEM-ON-CHIP COMPONENTS

(71) Applicant: ADVANCED MICRO DEVICES, INC., SUNNYVALE, CA (US)

(72) Inventors: Steven J. Kommrusch, Fort Collins, CO (US); Alexander J. Branover, Chestnut Hill, MA (US); Marvin A. Denman, Round Rock, TX (US)

(73) Assignee: ADVANCED MICRO DEVICES, INC., SUNNYVALE, CA (US)

(21) Appl. No.: 13/744,234

(22) Filed: Jan. 17, 2013

(51) Int. Cl. G06F 1/26

(52) U.S. Cl. CPC G06F 1/26
USPC 713/300

(57) ABSTRACT

Methods, apparatus, and fabrication relating to adaptive performance optimization of a plurality of components in view of power consumption and demand, component activity, and thermal events. A method may comprise allocating a first power budget to a first component of an apparatus, wherein the first power budget is less than a maximum power required by the first component; applying at least a portion of a borrowable power budget, wherein the borrowable power budget equals the maximum power required by the first component minus the first power budget, to a second component of the apparatus; and increasing the first power budget of the first component, in response to a first number or more of thermal events occurring in a first time period.

### BACKGROUND

1. Field of the Disclosure

Generally, the present disclosure relates to apparatus comprising electronic components, and, more particularly, to adaptive performance optimization of system-on-chip components.

2. Description of the Related Art

System-on-chip (SOC) approaches are commonly used in the art. SOCs comprise a plurality of components, each of which requires power. The amount of power a component requires at any given time will depend on the activities the component is engaged in at that time. However, typically, to each component is allocated a power budget corresponding to the component's maximum power requirement. If too small a power budget is allocated to a component, such that at various times the component's power requirement significantly exceeds the power budget for an extended period, thermal events may occur, leading to impaired function of the component, and possibly even damage to the component and/or reductions in the component's operating life. Further, typically, the power being consumed by a component at a given time is not known. In addition, the complexity of typical SOCs introduces non-trivial dependencies among and between power and performance. As a result, in known SOCs, power is often reserved for components that do not need it, thus leading to unnecessary power consumption, with concomitant increased operating expenses.

Attempts have been made to use software to adjust power consumption of SOC components. However, software attempts generally focus on each component, and do not take into account factors impacting the SOC as a whole. In addition, software attempts involve operations at several removes from the SOC, resulting in delays of up to tens of milliseconds in adjusting power consumption of SOC components. More frequent invocation of the software would tie up system resources, thereby reducing the SOCs ability to service user-requested processes.

Similar considerations apply to other, non-SOC-based computer systems and apparatus.

### SUMMARY OF EMBODIMENTS OF THE DISCLOSURE

The apparatus, systems, and methods in accordance with the embodiments of the present disclosure may optimize power consumption by system-on-chip (SOC) components by dynamically adjusting power consumption of the SOC components in view of thermal excursions occurring at various locations in the SOC. This can be done without detailed reports of power consumption by the various components of the SOC, thus allowing simpler design of power reporting channels and power management controllers. Mechanisms controlling the monitoring of thermal excursions and the dynamic adjustment of power consumption may be formed within a microcircuit by any means, such as by growing or deposition.

One apparatus in accordance with some embodiments of the present disclosure includes: a first component; a second component; and a processor configured to: allocate a first power budget to the first component, wherein the first power budget is less than the maximum power required by the first component; apply at least a portion of a borrowable power budget, wherein the borrowable power budget equals the maximum power required by the first component minus the first power budget, to the second component; and increase the first power budget of the first component, in response to a first number or more of thermal events occurring in a first time period.

One method in accordance with some embodiments of the present disclosure comprises allocating a first power budget to a first component of an apparatus, wherein the first power budget is less than the maximum power required by the first component; applying at least a portion of a borrowable power budget, wherein the borrowable power budget equals the maximum power required by the first component minus the first power budget, to a second component of the apparatus; and increasing the first power budget of the first component, in response to a first number or more of thermal events occurring in a first time period.

Some embodiments described herein may be used in any type of apparatus that manages power delivered to one or more components of the apparatus. One example is a computer system comprising a general purpose microprocessor.

### BRIEF DESCRIPTION OF THE FIGURES

The particular embodiments disclosed will hereafter be described with reference to the accompanying drawings, wherein like reference numerals denote like elements, and:

FIG. 1 is a simplified schematic diagram of a microcircuit design, in accordance with an embodiment of the disclosure.

FIG. 2A provides a representation of a silicon die/chip that includes one or more systems-on-chip as shown in FIG. 1, in accordance with an embodiment of the disclosure.

FIG. 2B provides a representation of a silicon wafer which includes one or more dies/chips that may be produced in a fabrication facility, in accordance with an embodiment of the disclosure.

FIG. 3 is a flowchart of a method relating to allocating power budgets of components of an apparatus, in accordance with an embodiment of the disclosure.

FIG. 4 is a flowchart of a method relating to calculating the dynamic power of components of an apparatus, in accordance with an embodiment of the disclosure.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the spirit and scope of the disclosed subject matter as defined by the appended claims.

### DETAILED DESCRIPTION

Some embodiments of the present disclosure provide for dynamic adjustment of power consumption of components of an apparatus in view of thermal excursions occurring at various locations in the apparatus. Some embodiments provide for calculation of the dynamic power of components of the apparatus.

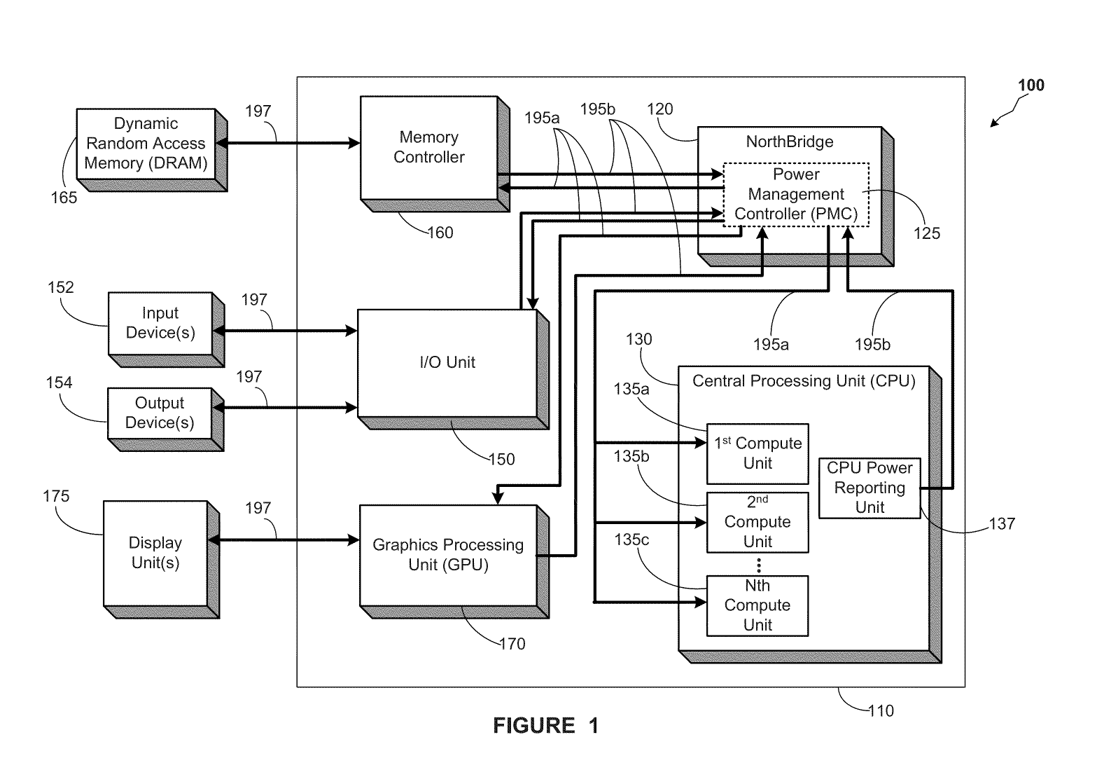

Turning now to FIG. 1, a block diagram, a stylized representation of a computer system 100, comprising a system-on-chip (SOC) 110, is illustrated. The SOC 110 may comprise a northbridge 120. The northbridge 120 may perform various operations known the person of ordinary skill in the art. Among its various components (not shown), the northbridge 120 may comprise a power management controller (PMC) 125. The PMC 125 may be configured to issue power management directives to other components of the SOC 110 via data channels 195a, and receive power reports from other components of the SOC 110 via data channels 195b.

The SOC 110 may comprise a central processing unit (CPU) 130. The CPU 130 may comprise a plurality of compute units 135, such as a first compute unit 135a, a second compute unit 135b, through an nth compute unit 135c. A compute unit 135a, 135b, or 135c may be referred to as a “CPU core.” The CPU 130 may also comprise a CPU power reporting unit 137. The CPU power reporting unit 137 may send power reports relating to the CPU 130 to the PMC 125 via a data channel 195b. Each of the compute units 135 may receive power management directives from the PMC 125 via a data channel 195a.

The SOC 110 may also comprise other components, such as an I/O unit 150 configured to receive user input from input devices 152 (e.g., keyboards, mice, trackballs, touchpads, touchscreens, microphones, etc.) and send output to output devices 154 (e.g., speakers, headphones, etc.) via data channels 197. The I/O unit 150 and/or subcomponents thereof may receive power management directives from the PMC 125 via a data channel 195a and may send power reports to the PMC 125 via a data channel 195b.

The SOC 110 may also comprise a memory controller 160 configured to send and receive data to a memory, such as a dynamic random access memory (DRAM) 165, via a data channel 197. The memory controller 160 and/or subcomponents thereof may receive power management directives from the PMC 125 via a data channel 195a and may send power reports to the PMC 125 via a data channel 195b.

The SOC 110 may also comprise a graphics processing unit (GPU) 160 configured to send output to display unit(s) 175 via a data channel 197. The GPU 170 and/or subcomponents thereof may receive power management directives from the PMC 125 via a data channel 195a and may send power reports to the PMC 125 via a data channel 195b. In particular embodiments (not shown), the GPU 170 may comprise one or more GPU cores, similar to the compute units 135 shown in the CPU 130.

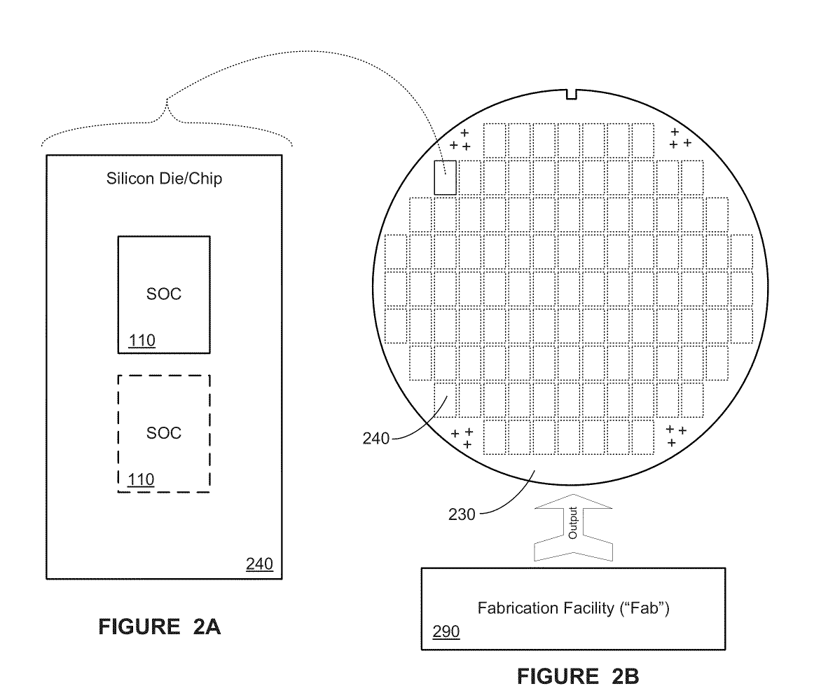

Turning now to FIG. 2A, in some embodiments, the SOC 110 of the apparatus may reside on a silicon die/chip 240. The silicon die/chip 240 may be housed on a motherboard or other structure of a computer system. In one or more embodiments, there may be more than one SOC 110 on each silicon die/chip 240. Various embodiments of the SOC 110 may be used in a wide variety of electronic devices.

Turning now to FIG. 2B, in accordance with some embodiments, and as described above, the SOC 110 may be included on the silicon chip/die 240. The silicon chip/die 240 may contain one or more different configurations of the SOC 110. The silicon chip/die 240 may be produced on a silicon wafer 230 in a fabrication facility (or “fab”) 290. That is, the silicon wafer 230 and the silicon die/chip 240 may be referred to as the output, or product of, the fab 290. The silicon chip/die 240 may be used in electronic devices.

The circuits described herein may be formed on a semiconductor material by any known means in the art. Forming can be done, for example, by growing or deposition, or by any other means known in the art. Different kinds of hardware descriptive languages (HDL) may be used in the process of designing and manufacturing the microcircuit devices. Examples include VHDL and Verilog/Verilog-XL. In some embodiments, the HDL code (e.g., register transfer level (RTL) code/data) may be used to generate GDS data, GDSII data and the like. GDSII data, for example, is a descriptive file format and may be used in different embodiments to represent a three-dimensional model of a semiconductor product or device. Such models may be used by semiconductor manufacturing facilities to create semiconductor products and/or devices. The GDSII data may be stored as a database or other program storage structure. This data may also be stored on a computer readable storage device (e.g., data storage units, RAMs, compact discs, DVDs, solid state storage and the like) and, in some embodiments, may be used to configure a manufacturing facility (e.g., through the use of mask works) to create devices capable of embodying various aspects of the instant disclosure. As understood by one or ordinary skill in the art, it may be programmed into a computer, processor, or controller, which may then control, in whole or part, the operation of a semiconductor manufacturing facility (or fab) to create semiconductor products and devices. These tools may be used to construct the embodiments of the disclosure described herein.

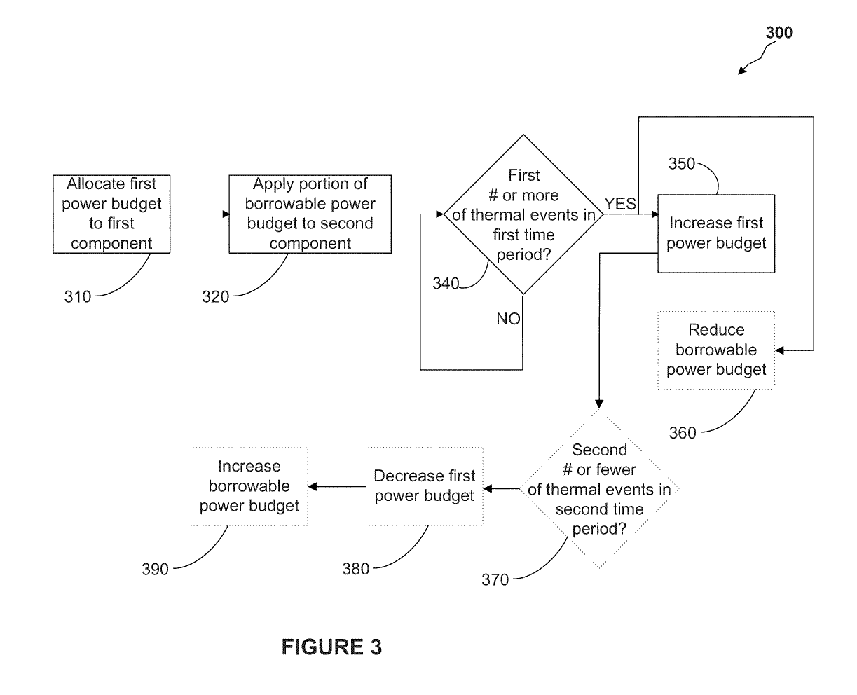

FIG. 3 presents a flowchart depicting a method 300 according to some embodiments of the present disclosure. In the depicted embodiment, the method 300 may comprise allocating at 310 a first power budget to a first component of an apparatus, wherein the first power budget is less than the maximum power required by the first component. In some embodiments, the first component may be an I/O engine (e.g., I/O unit 150), a display interface (e.g., GPU 170), or a memory interface (e.g., memory controller 160). The method 300 may comprise applying at 320 at least a portion of a borrowable power budget, wherein the borrowable power budget equals the maximum power required by the first component minus the first power budget, to a second component of the apparatus. In some embodiments, the second component may be a CPU core or a GPU core.

Prior to the applying at 320, the second component may have a baseline second power budget; after the applying at 320, the second component may have an increased second power budget, wherein the increased second power budget equals the baseline second power budget plus the applied portion of the borrowable power budget.

A determination at 340 may be made of the occurrence of a first number or more of thermal events in a first time period. A “thermal event” here refers to an excursion of the temperature of a location within the apparatus to a temperature outside a desired operating range, e.g., above an upper threshold temperature or below a lower threshold temperature. In some embodiments, the thermal event is an increase above an upper threshold temperature. A temperature excursion may require some minimum duration or another indicator it is not a false positive to be considered a true “thermal event” rather than a product of noise in the temperature sensing apparatus and/or another cause of error. Further, the upper and/or lower thresholds of the desired operating range may be adjustable during and/or between performances of the method 300, in light of other factors (ambient temperature and other weather conditions, past history of thermal events, etc.).

Thermal events may arise from a demand for power by the first component in excess of the first power budget allocated thereto. The excess demand for power may be transient, i.e., may be required only because one or more typically-quiescent circuits of the first component may be activated to perform a short-term task. In some embodiments, thermal events may occur in the first component. Alternatively or in addition, thermal events may occur at one or more locations in the apparatus, i.e., not necessarily in the first component.

If it is determined at 340 that a first number or more of thermal events occurred in a first time period, the method may comprise increasing at 350 the first power budget of the first component. Increasing at 350 may provide sufficient power to satisfy the first component's power demand. In the absence of such a determination at 340, flow may return, after any desired delay, to determining at 340.

The method 300 may further comprise reducing at 360 the borrowable power budget, in response to determining at 340 the first number or more of thermal events in the first time period. By doing so, the power budget of the second component may be reduced from the increased second power budget to a lower second power budget, which may be as low as the baseline second power budget.

The method 300 may further comprise decreasing at 380 the first power budget, subsequent the increasing at 350, in response to a determination at 370 that a second number or fewer of thermal events in a second time period occurred.

The method 300 may further comprise increasing at 390 the borrowable power budget, in response to the determination at 370 that the second number or fewer of thermal events in the second time period occurred.

By way of example, an FCH of a typical I/O unit requires a maximum power of about 400 mW, relating to user activity involving most of the I/O interfaces. However, in a typical idle state, the FCH requires only about 30 mW. In prior techniques, the FCH was typically allocated a fairly high, constant, power budget, e.g., about 200 mW, meaning that most of the time, about 170 mW were unnecessarily allocated to the FCH. In contrast, in accordance with one embodiment of the present disclosure, the FCH may be allocated a first power budget of 30 mW, and at least a portion of the (400 mW−30 mW=) 370 mW headroom between the FCH's maximum power requirement and the first power budget may be borrowed by a second component, e.g., a CPU core or a GPU core. Then, if a user activates one or more I/O functions, and a high rate of thermal events occur, either within the FCH, the I/O unit, or other components, the first power budget may be increased to provide the higher power required by the FCH at that time. This may involve returning some or all of the power borrowed by the second component to the FCH. Later, when the user no longer desires I/O functions, the first power budget may be decreased, such as back to 30 mW.

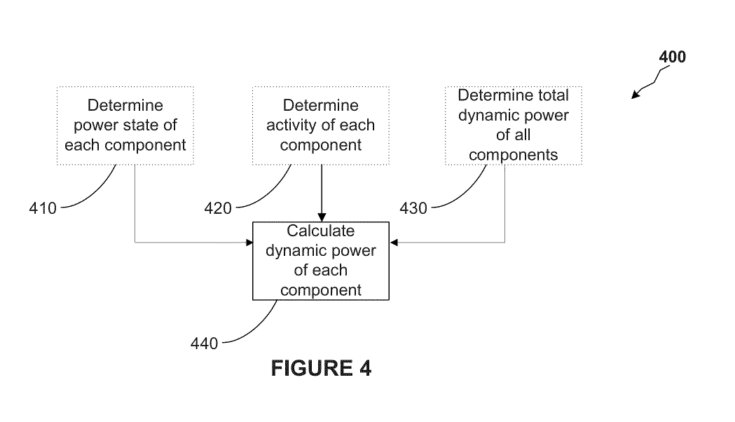

FIG. 4 presents a flowchart depicting a method 400 according to some embodiments of the present disclosure. In some embodiments, the method 400 may comprise calculating at 440 a dynamic power of each of a plurality of components of an apparatus, based on the power state of each component, the activity of each component, and the total dynamic power of the plurality of components. In some embodiments, the method 400 may further comprise one or more of: determining at 410 a power state of each of a plurality of components of an apparatus, e.g., whether each of the components is in a powered-off state, a clock-off state, or a normal power state; determining at 420 an activity of each component; or determining at 430 a total dynamic power of the plurality of components, e.g., how much power is being consumed by all the components.

The activity of each component may be determined at 420 based at least in part on microoperations per time period, cache reads per time period, cache writes per time period, floating point activity per time period, or two or more thereof.

In some embodiments, each of the plurality of components is a core of a CPU or a core of a GPU.

The methods illustrated in FIGS. 3-4 may be governed by instructions that are stored in a non-transitory computer readable storage medium and that are executed by at least one processor of the computer system 100. Each of the operations shown in FIGS. 3-4 may correspond to instructions stored in a non-transitory computer memory or computer readable storage medium. In various embodiments, the non-transitory computer readable storage medium includes a magnetic or optical disk storage device, solid state storage devices such as flash memory, or other non-volatile memory device or devices. The computer readable instructions stored on the non-transitory computer readable storage medium may be in source code, assembly language code, object code, or other instruction format that is interpreted and/or executable by one or more processors.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the disclosed subject matter. Accordingly, the protection sought herein is as set forth in the claims below.

What is claimed:

1. A method, comprising:
allocating a first power budget to a first component of an apparatus, wherein the first power budget is less than a maximum power required by the first component;
applying at least a portion of a borrowable power budget, wherein the borrowable power budget equals the maximum power required by the first component minus the first power budget, to a second component of the apparatus; and
increasing the first power budget of the first component, in response to a first number or more of thermal events occurring in a first time period.

2. The method of claim 1, wherein the first component is selected from an I/O engine, a display interface, or a memory interface; and the second component is selected from a CPU core or a GPU core.

3. The method of claim 2, wherein the first component is a memory interface configured to send and receive data to a memory.

4. The method of claim 2, wherein the first component is an I/O engine configured to at least one of receive user input from an input device and send output to an output device.

5. The method of claim 2, wherein the first component is a display interface configured to send data to a display unit.

6. The method of claim 1, further comprising: reducing the borrowable power budget, in response to the first number or more of thermal events occurring in the first time period.

7. The method of claim 1, wherein the one or more thermal events occur in the first component.

8. The method of claim 1, wherein the one or more thermal events occur at one or more locations in the apparatus.

9. The method of claim 1, further comprising:
decreasing the first power budget, subsequent the increasing, in response to a second number or fewer of thermal events occurring in a second time period.

10. The method of claim 9, further comprising:
increasing the borrowable power budget, in response to the second number or fewer of thermal events occurring in the second time period.

11. A method, comprising:
calculating a dynamic power of each of a plurality of components of an apparatus, based on a power state of each component, an activity of each component, and a total dynamic power of the plurality of components.

12. The method of claim 11, further comprising at least one of:
determining a power state of each of a plurality of components of an integrated circuit device;
determining an activity of each component; or
determining a total dynamic power of the plurality of components.

13. The method of claim 12, wherein the activity is determined based at least in part on microoperations per time period, cache reads per time period, cache writes per time period, floating point activity per time period, or two or more thereof.

14. The method of claim 11, wherein each of the plurality of components is a core of a CPU or a core of a GPU.

15. An apparatus, comprising:
a first component;
a second component; and
a processor configured to:
allocate a first power budget to the first component, wherein the first power budget is less than the maximum power required by the first component;
apply at least a portion of a borrowable power budget to the second component, wherein the borrowable power budget equals the maximum power required by the first component minus the first power budget; and
increase the first power budget of the first component, in response to a first number or more of thermal events occurring in a first time period.

16. The apparatus of claim 15, wherein the first component is selected from an I/O engine, a display interface, or a memory interface; and the second component is selected from a CPU core or a GPU core.

17. The apparatus of claim 15, wherein the first component is an I/O engine configured to at least one of receive user input from an input device and send output to an output device.

18. The apparatus of claim 15, wherein the first component is a memory interface configured to send and receive data to a memory.

19. The apparatus of claim 15, wherein the first component is a display interface configured to send data to a display unit.

20. The apparatus of claim 15, wherein the processor is further configured to:
reduce the borrowable power budget, in response to the first number or more of thermal events occurring in the first time period.

21. The apparatus of claim 15, wherein the processor is configured to observe one or more thermal events in the first component.

22. The apparatus of claim 15, wherein the processor is configured to observe one or more thermal events at one or more locations in the apparatus.

23. The apparatus of claim 15, wherein the processor is further configured to:
decrease the first power budget, subsequent the increasing, in response to a second number or fewer of thermal events occurring in a second time period.

24. The apparatus of claim 23, wherein the processor is further configured to:
increase the borrowable power budget, in response to the second number or fewer of thermal events occurring in the second time period.

25. An apparatus, comprising:
a plurality of components; and
a processor configured to:
calculate a dynamic power of each component, based on a power state of each component, an activity of each component, and a total dynamic power of the plurality of components.

26. The apparatus of claim 25, wherein the processor is further configured to at least one of:
determine a power state of each of a plurality of components of an integrated circuit device;
determine an activity of each component; or
determine a total dynamic power of the plurality of components.

27. The apparatus of claim 26, wherein the activity is determined based at least in part on microoperations per time period, cache reads per time period, cache writes per time period, floating point activity per time period, or two or more thereof.

28. The apparatus of claim 26, wherein each of the plurality of components is a core of a CPU or a core of a GPU.

29. A non-transitory computer readable storage medium encoded with data that, when implemented in a manufacturing facility, adapts the manufacturing facility to create an apparatus, comprising:
a first component;
a second component; and
a processor configured to:
allocate a first power budget to the first component, wherein the first power budget is less than the maximum power required by the first component;
apply at least a portion of a borrowable power budget, wherein the borrowable power budget equals the maximum power required by the first component minus the first power budget, to the second component; and
increase the first power budget of the first component, in response to a first number or more of thermal events occurring in a first time period.

30. A non-transitory computer readable storage medium encoded with data that, when implemented in a manufacturing facility, adapts the manufacturing facility to create an apparatus, comprising:
a plurality of components; and
a processor configured to:
calculate a dynamic power of each component, based on a power state of each component, an activity of each component, and a total dynamic power of the plurality of components.
